(19) United States
(12) Patent Application Publication
(10) Pub. No.: US 2025/0276757 A1
(43) Pub. Date: Sep. 4, 2025

(54) Vehicle Driven by an Electric Motor and Display Unit for a Vehicle Driven by an Electric Motor

(71) Applicant: Robert Bosch GmbH, Stuttgart (DE)

(72) Inventor: Simon Henzler, Metzingen (DE)

(21) Appl. No.: 19/065,718

(22) Filed: Feb. 27, 2025

(30) Foreign Application Priority Data
Mar. 1, 2024 (DE) 10 2024 201 936.4

(51) Int. Cl. B62J 50/21; B62K 1/00; B62M 6/40

(52) U.S. Cl. CPC B62J 50/225; B62K 1/00; B62M 6/40

(57) ABSTRACT

A vehicle driven by an electric motor, in particular a one-wheeler or two-wheeler driven by an electric motor has a frame. A display unit for interaction of a rider with the vehicle driven by an electric motor is provided in a surface of the frame. A surface of the display unit is integrated flush with the surface of the frame such that a plane is formed by an intermediate layer arranged between the display unit and the frame.

This application claims priority under 35 U.S.C. § 119 to patent application no. DE 10 2024 201 936.4, filed on Mar. 1, 2024 in Germany, the disclosure of which is incorporated herein by reference in its entirety.

The disclosure relates to a vehicle driven by an electric motor, in particular to a one-wheeler or two-wheeler driven by an electric motor, having a frame, as well as a display unit for a vehicle driven by an electric motor.

### BACKGROUND

It is known to provide a display unit with a display for interaction of a rider with the two-wheeler in a surface of an upper tube of the frame of a two-wheeler driven by an electric motor arranged between the handlebar and the saddle. Such solutions have already been introduced, for example, by manufacturers such as Brose or Giant, in which the display unit is raised and inserted into the upper tube. In VanMoof, the display of the display unit is also integrated into a translucent upper tube such that its light mechanism shines through the upper tube. However, this means that the display only has a very low resolution for the rough status display of individual items of information.

It is the object of the disclosure to provide an improved display unit in the frame of a vehicle driven by an electric motor compared to the prior art, which is as insensitive to movements of the frame and to weather and other environmental influences as possible.

### SUMMARY

To achieve the object, it is provided that a surface of the display unit is integrated flush with the surface of the frame such that a plane is formed by an intermediate layer arranged between the display unit and the frame. The flush surfaces of the display unit and frame make it as insensitive to water, dust and dirt as possible. Flush should be understood to mean that the surfaces substantially form a plane on which no water, dust or dirt can build up in any imperfections, such as depressions, gaps, elevations or the like. It should be noted, however, that the surfaces forming the plane may become quite dirty themselves during normal use, as they do not necessarily have to be coated such that they are water or dirt repellent. In this context, a plane is intended to mean that the individual surfaces have only a minimum height offset of less than 0.1 mm.

For example, the vehicle driven by an electric motor may be configured as an electric bicycle (e.g., EPAC-Electrically Power Assisted Cycle, e-bike, pedelec, e-cargo bicycle, etc.), an electric motorbike, a one- or two-wheeled e-scooter, an e-moped or the like. The disclosure is also applicable to other applications in the field of micro-mobility applications such as e-kick scooters, mono-wheels or other non-type-approved vehicles with fixed or interchangeable battery packs installed in the vehicle. A vehicle driven by an electric motor is therefore also to be understood as a vehicle that has a drive unit to assist the rider or an electromotive partial drive.

The energy supply for the vehicle driven by an electric motor is provided by an energy storage unit, which is either fixedly integrated in the vehicle or can be configured as a exchangeable battery pack that can be removed without tools. In the case of an exchangeable battery pack, it may also be provided that it can be charged both in the state connected to the vehicle driven by an electric motor and in the state disconnected from the vehicle driven by an electric motor. The battery voltage of the energy storage unit is usually a multiple of the voltage of a single energy storage cell of the energy storage unit and results from the interconnection (parallel and/or series) of the individual energy storage cells. Preferably, the energy storage cells are configured as lithium-based energy storage cells, e.g., Li-ion, Li-polymer, Li-metal, Na-ion or the like. However, the disclosure can also be applied to energy storage cells having Ni—Cd cells, NiMH cells or other suitable cell types. For common Li-ion energy storage cells with a cell voltage of 3.6 V, nominal battery voltages of 3.6 V, 18 V, 36 V, 54 V, etc. result by way of example. However, the disclosure does not depend on the type and design of the energy storage cells and the energy storage unit used, but can be applied to any electrochemical energy storage units and energy storage cells, e.g., in addition to round cells and pouch cells or the like, with battery voltages of 36 V, 48 V, 52 V or the like.

A display unit is to be understood as a component unit that can be separated from the frame of the vehicle with its own housing and a display, in particular a touch display, for interaction by the rider with the vehicle. The display unit serves, among other things, to inform the rider about various states (e.g., charging state of the energy storage unit, switching state of a gear shift, state of a vehicle lighting or the like). The display unit may also be configured as an on-board computer having an integrated processor and optionally integrated sensors for navigation, air pressure measurement, temperature measurement, brightness measurement or the like. In this context, individual components of the vehicle may be directly controlled via the display unit, in particular via the touch display or via separate buttons.

In a further development, it is provided that the intermediate layer is connected to a housing of the display unit in a material-locking manner. In this way, the display unit can be installed in the frame in a particularly easy manner, as it is already configured as a pre-assembled module due to the intermediate layer connected to the housing. For this purpose, the display unit has at least one fastening mechanism, in particular a screw or a screw receptacle and a tolerance compensation element, in particular a leaf spring, for fastening in the frame. A display configured as a touch display allows the operator to actively interact with the vehicle driven by an electric motor by finger control in a very straightforward manner, for example, to affect shifting behavior of a gear shift, a lighting situation of a vehicle lighting, an energy control for a vehicle battery, a vehicle navigation or the like.

The intermediate layer preferably consists of an elastic material, in particular a thermoplastic elastomer or silicone. In this context, the intermediate layer can be more elastic than the housing. An elastic intermediate layer simplifies the particularly flush integration of the display unit into the frame, as this can compensate for any manufacturing and assembly tolerances. In addition, relative movements can be compensated between the display unit and the frame, which can arise, for example, as a result of deformations of the frame in the event of jumps, falls or strong changes in direction with the vehicle driven by an electric motor.

In the assembled state, the intermediate layer of the display unit is deformed, in particular compressed, in order to ensure the tightest possible fit of the display unit in the frame. In order to avoid the intrusion of fluid into the frame, for example during cleaning of the vehicle driven by an electric motor or during heavy rain, the intermediate layer is configured as a seal between the frame and the display unit.

It is also an object of the disclosure to provide an improved display unit in the frame of a vehicle driven by an electric motor compared to the prior art that, on the one hand, provides a surface that is as insensitive to weather and other environmental influences as possible, and on the other hand, provides a wired connection option for external devices.

To achieve the object, it is provided that the display unit has a surface with a display, in particular a touch display, and a connection socket embedded in the surface for data and/or energy transfer, wherein the surface of the display unit is integrated flush with the surface of the frame and the connection socket is recessed relative to the surfaces. Due to the flush surfaces, the display is thus as insensitive to water, dust and dirt as possible, while the connection socket can be used for data and/or energy transfer from or to external devices, such as a smartphone or the like.

In a further development, it is provided that the connection socket can be closed with a cover cap such that the cover cap is flush with the surfaces. The connection socket itself is thus also protected from any weather and other environmental influences.

The cover cap may be made of a rigid material, in particular a thermoplastic, such as PC-ABS, and/or an elastic material, in particular a thermoplastic elastomer, silicone or rubber. For example, a two-component cover cap may be configured such that its cover is made of a rigid material and its hinge, which is needed to open and close the lid, is made of an elastic material. This results in a good sealing function of the cover cap on the one hand and a long service life on the other. In addition, replacing a damaged cover cap can be facilitated.

In an alternative configuration, it is provided that the connection socket is rotatable about an axis of rotation such that it is flush with the surfaces in the closed state. As a result, a separate cover cap can be dispensed with. However, such a configured connection socket requires a larger design space and, if necessary, more complexly manufactured contacts.

The connection socket has an electromechanical interface raised opposite a laminar recess surrounding it. Thus, fluids may not run directly into the electromechanical interface in order to avoid corrosion or any short circuits of the electrical contacts of the electromechanical interface. With particular advantage, the housing of the display unit has a drain channel connected to the recess. The fluids can thereby be discharged into the upper tube via the housing or through the upper tube. With particular advantage, the connection socket is configured as a USB-C socket. However, other sockets for data and/or energy transfer, such as USB-A, micro-USB, round sockets or the like, are possible.

A further object of the disclosure can be seen in providing an improved display unit in the frame of a vehicle driven by an electric motor compared to the prior art that is able to reliably inform the rider acoustically of the vehicle of any status changes, warnings and/or alerts in the long term.

To achieve the object, it is provided that the display unit has a sound transducer arranged in the display unit in such a way that it is protected from weather influences. With particular advantage, acoustic information of the rider can be ensured over a long period of time independent of external influences.

In a further development, it is provided that the sound transducer can generate a sound level of at least 2.7 sones at a distance of approximately 70 cm. In this way, a sufficiently loud signal is also ensured at the rider's ear during the journey.

In a further development, it is provided that the sound transducer is configured as a piezo speaker, which is arranged on a bottom side of a display, in particular a touch display, of the display unit, so that it stimulates the display to generate sound. With particular advantage, the sound transducer can thus be configured very flat on the one hand, and transfer sufficient sound energy, on the other hand, due to the display facing the rider. In addition, the display can be completely sealed against weather and other environmental influences by way of a closed housing.

In an alternative configuration, the display unit comprises a housing, wherein the sound transducer is arranged on a printed circuit board within the housing, such that the sound generated by it emerges through an opening of the housing arranged away from the surface of the frame. The sound transducer may preferably be configured as a dynamic speaker or buzzer.

Within the housing, an acoustic chamber is additionally formed for guiding the sound from the sound transducer towards the opening. The acoustic chamber may be configured as a sub-housing surrounding the sound transducer, which is preferably made of an elastomer. In this way, the sound waves are concentrated and directed downwards into the upper tube. The opening is protected from weather and environmental influences due to the downwardly open configuration of the housing. At the same time, a sufficient sound level may be produced for the rider of the vehicle driven by an electric motor. In addition, installation within the housing is facilitated when a main extension plane of the printed circuit board is aligned parallel to the display.

In the assembled state, the intermediate layer of the display unit is deformed, in particular compressed, in order to ensure the tightest possible fit of the display unit in the frame. With particular advantage, the intermediate layer also allows for improved sound dissipation, as unfavorable resonances between the display unit and the frame can be avoided, for example.

In a further embodiment, the vehicle driven by an electric motor has a handlebar and a saddle, wherein an upper tube of the frame is arranged between the handlebar and the saddle, into the surface of which the display unit is integrated, in particular flush. The upper tube of the frame is particularly advantageous for the integration of the display unit, as the rider always has a good, straight-forward view of the display of the display unit. As a result of the usually inclined arrangement of the upper tube in the frame, fluids and other dirt are also less likely to adhere to the surface of the display unit.

### BRIEF DESCRIPTION OF THE DRAWINGS

The disclosure is explained below with reference to FIGS. 1 through 9 by way of example, wherein identical reference numbers in the drawings indicate identical components having an identical function.

Shown are

FIG. 1: a schematic illustration of a vehicle driven by an electric motor configured as a two-wheeled electric bicycle with a frame,

FIG. 2: a display unit integrated in an upper tube of the frame in a section along a vertically extending longitudinal plane of the upper tube,

FIG. 3: the display unit with a housing in a perspective view from its bottom side,

FIG. 4: the empty housing of the display unit in a further perspective view,

FIG. 5: a further exemplary embodiment of the display unit in a top perspective view,

FIG. 6: the display unit in a section running parallel to the surfaces of the display unit and/or the upper tube from below,

FIG. 7: a connection socket of the display unit in a perspective detail view,

FIG. 8: the display unit in a perspective cut perpendicular to the surfaces of the display unit and/or the upper tube, and

FIG. 9: the display unit in a further perspective view with the cover cap removed.

### DETAILED DESCRIPTION

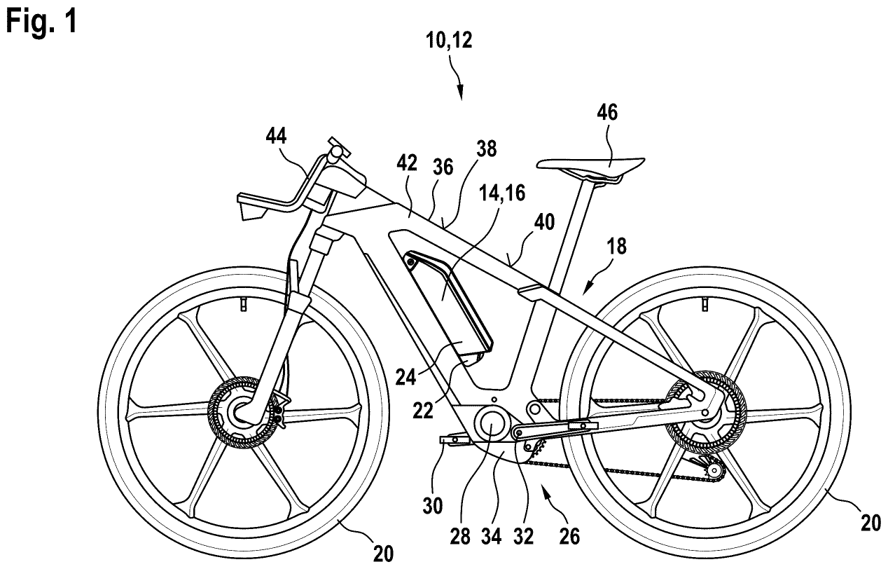

FIG. 1 shows a schematic illustration of a vehicle driven by an electric motor 10 configured as a two-wheeled electric bicycle 12. The electric bicycle 12 is powered by an energy storage unit 16 configured as an exchangeable battery pack 14 and may be configured as, for example, a pedelec, an e-bike or the like. The electric bicycle 12 has a housing in the form of a frame 18 with two wheels 20 supported in the frame 18. The exchangeable battery pack 14 is releasably connected via a connection device 22 provided on the frame 18, which electro-mechanically cooperates with an interface (not shown in more detail) attached to an outer housing 24 of the exchangeable battery pack 14.

The electric bicycle 12 further has a drive unit 26, which comprises an electric motor 28, preferably in the form of an EC or BLDC motor, in the form of a center motor. Alternatively, a hub motor may also be used in one of the wheels 20 instead of a center motor. The drive unit 26 is also powered by the exchangeable battery pack 14 and comprises an electronic unit (not shown) for controlling or regulating the electric bicycle 12, in particular the electric motor 28. The electronic unit is also connected to a sensor unit (also not shown) that, by way of example, comprises a torque sensor, a rotation rate sensor, a motion sensor, a magnetic sensor or the like, to detect the motor data. A pedal crank 30 with a pedal crankshaft 32 is further provided on the electric bicycle 12, via which the rider can perform a pedaling movement to drive the rear wheel 20 in the manner of a conventional bicycle drive. The electronic unit, the drive unit 26 having the electric motor 28 and the pedal crankshaft 32 are arranged within a drive housing 34 connected to the frame 18.

The drive movement of the electric motor 28 is preferably transmitted to the pedal crankshaft 32 via a transmission (not shown), wherein the intensity of the assistance by the drive unit 26 is controlled or regulated via the electronic unit. The electronic unit is configured to control the drive unit 26 such that the rider of the electric bicycle 12 is assisted in pedaling. Preferably, the electronic unit is configured such that it can be operated by the rider so that the rider can set the assistance level.

The electric bicycle 12 comprises a display unit 36, the surface 38 of which is integrated flush with a surface 40 of an upper tube 42 of the frame 18, such that the two surfaces 38, 40 form a plane. In this context, a plane is to be understood to mean that the two surfaces 38, 40 have only a minimum height offset of less than 0.1 mm. The upper tube 42 is in turn arranged between a handlebar 44 and a saddle 46 of the electric bicycle 12. It is further noted that the display unit 36 may also be integrated into the frame 18 at other positions. Women's bicycles in particular do not have any explicit upper or lower tubes, but rather combine these two tubes in a common tube, into which the display unit 36 can then be integrated. Integration into a stem of the frame 18 is also possible.

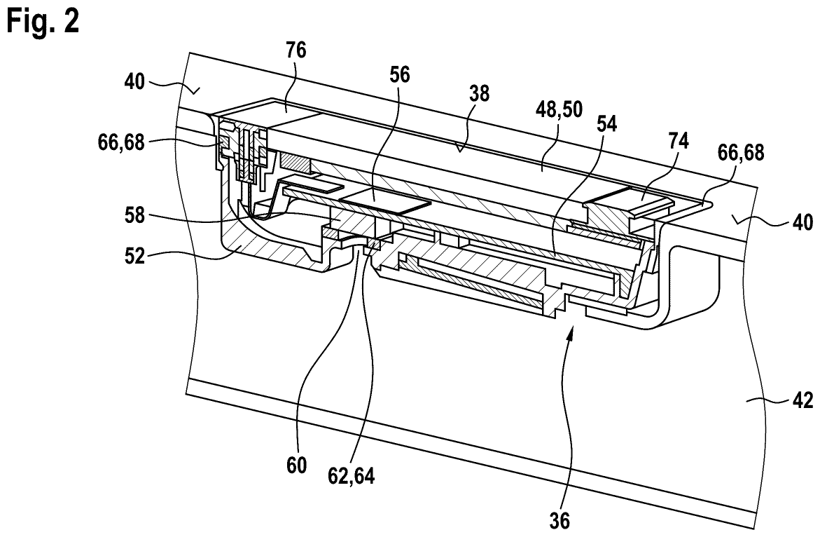

In FIG. 2, the display unit 36 integrated into the upper tube 42 is shown in a section along a vertically extending longitudinal plane of the upper tube 42 and/or the frame 18. The display unit 36 comprises a display 50 configured as a touch display 48, which is used to display information and/or to operate the display unit 36 and/or to control the drive unit 26 and/or the wheel 20 driving the electric bicycle 12. The touch display 48 in turn forms the surface 38 of the display unit 36, which is flush with the surface 40 of the upper tube 42. With particular advantage, the rider can thus actively interact with the electric bicycle 12 by finger control, for example in order to influence a shifting behavior of a gear shift, a lighting situation of a lighting of the electric bicycle 12, an energy control for the exchangeable battery pack 14 of the electric bicycle 12, a vehicle navigation or the like, while the touch display 48 is as insensitive to water, dust and dirt as possible due to its slope and the plane formed with the upper tube 42. The display unit 36 is connected to the drive unit 26 for exchanging information and commands. In addition to the aforementioned sensor unit for the electric motor 28, there is a connection to various sensor units that can detect different data from the electric bicycle 12 (e.g., speed, acceleration, slope, cadence, etc.), the environment (e.g., air pressure, brightness, etc.) and/or the rider (e.g., heart rate, blood oxygen content, etc.). The connection can be configured via cable or wirelessly, e.g., via Bluetooth. In this way, for example, touch display 48 may display a determined speed, a set level of assistance of the electric motor 28, route information of a navigation unit integrated in the display unit 36, a charging state of the exchangeable battery pack 14 or the like.

The display unit 36 has a housing 52 in which a printed circuit board 54 is arranged in addition to the touch display 48, among other things. The printed circuit board 54 is arranged in the housing 52 such that a main extension plane of the printed circuit board 54 is oriented parallel to the touch display 48. It carries various semiconductor components of an electronic unit 56, such as microprocessors, resistors, capacitors, transistors, diodes, chokes, sensors, etc., which will not be discussed further here, however, as the structure of the electronic unit 50 is not intended to be an object of the disclosure. On the side of the printed circuit board 54 opposite the electronic unit 56 and the touch display 48, a sound transducer 58 is arranged such that the sound generated by it exits an opening 60 of the housing 52 arranged away from the surface 40 of the upper tube 42. For example, the sound transducer 58 is configured as a dynamic speaker, a buzzer or the like. Within the housing 52, a sub-housing 62 surrounds the sound transducer 58 to form an acoustic chamber 64 for guiding the sound from the sound transducer 58 to the opening 60. The sub-housing 62 is preferably formed from an elastomeric material between the printed circuit board 54 and the housing 52 for better sound sealing. It is also possible, however, that the sub-housing 62 may be made of a thermoplastic and/or the same material as the housing 52. The sub-housing 62 thus allows the use of different sound transducers 58 within the housing 52 by a corresponding adjustment. On the one hand, the sub-housing 52 concentrates the sound waves and directs them downwards into the upper tube 42, while on the other hand, the opening 60 and consequently also the printed circuit board 54 together with the sound transducer 58 and the electronic unit 56 are protected from weather and environmental influences by the downwardly open configuration of the housing 52. At the same time, a sufficient sound level of at least 2.7 sones can be generated at the rider's ear, i.e., approximately 70 cm away from the surface 40 of the upper tube 42 and the frame 18.

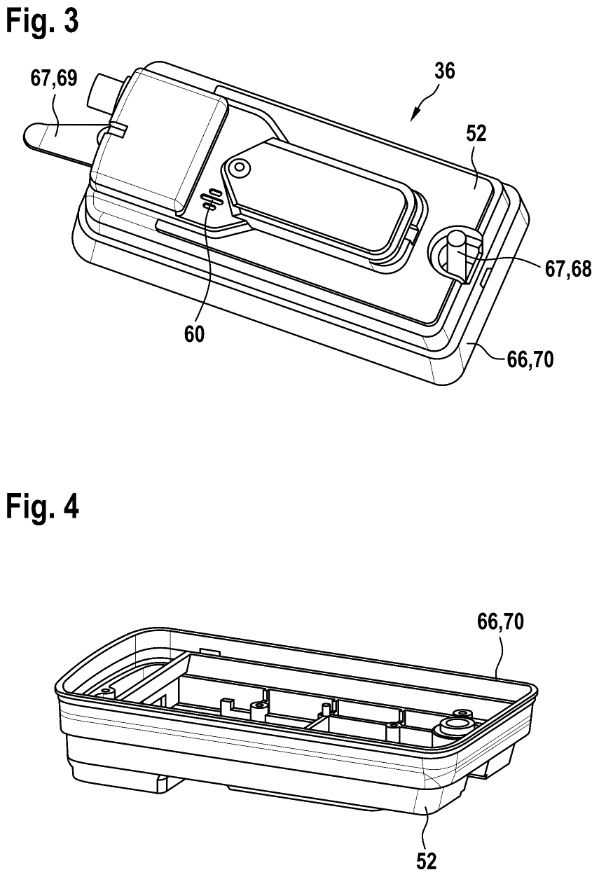

FIG. 3 shows the display unit 36 with the housing 52 in a perspective view from its bottom side. The opening 60 for the sound outlet is clearly visible. Furthermore, the housing 52 is connected in a material-locking manner to an intermediate layer 66 made of an elastic material, in particular a thermoplastic elastomer or silicone. The intermediate layer 66 is arranged between the surfaces 38, 40 of the upper tube 42 and the display unit 36 such that, in the assembled state of the display unit 36, it forms a plane of the two surfaces 38, 40 (also see FIG. 2). The material-locking connection of the intermediate layer 66 to the housing 52 results in a particularly simple assembly of the display unit 36 in the upper tube 42, as the display unit 36 is thus configured as a pre-assembled module. For this purpose, the display unit 36 has a fastening mechanism 67 in the form of a screw dome 68 and a tolerance compensation element 69 configured as a leaf spring for fastening in the upper tube 40 of the frame 18.

For further illustration, in FIG. 4, the empty housing 52 of the display unit 36 with the intermediate layer 66 is shown in a further perspective view. The intermediate layer 66 simplifies the flush integration of the touch display 48 into the upper tube 42, as this may compensate for any manufacturing and assembly tolerances. In addition, relative movements can be compensated between the display unit 36 and the upper tube 42, which can arise, for example, as a result of deformations of the frame 18 in the event of jumps, falls or strong changes in direction with the electric bicycle 12. In order to avoid the intrusion of fluid into the upper tube 42, for example during cleaning of the electric bicycle 12 or during heavy rain, the intermediate layer 66 is configured as a seal 70b between the upper tube 42 and the display unit 36.

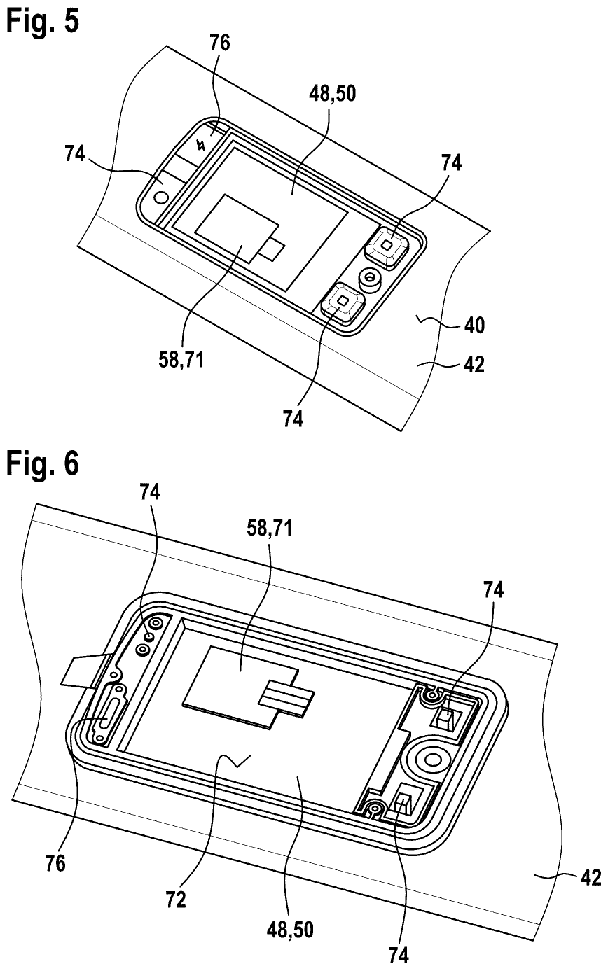

In FIGS. 5 and 6, a further exemplary embodiment of the display unit 36 is shown in a top perspective view (FIG. 5) and a bottom section (FIG. 6) running parallel to the surfaces 38, 40 of the display unit 38 and/or the upper tube 42. Instead of a dynamic speaker or buzzer, the sound transducer 58 is configured as a very flat-mounted piezo speaker 71, for example a so-called PiezoListen speaker from TDK, which is arranged on a bottom side 72 of the touch display 48 such that it stimulates the touch display 48 to generate sound. Thus, sufficient sound energy, in particular the aforementioned 2.7 sones at a distance of approximately 70 cm, can be transmitted to the rider through the touch display 48 facing the rider. In contrast to the previous exemplary embodiment, the housing 52 can thereby be completely closed in order to protect the display unit 36 from weather and other environmental influences. It is still noted that the touch display 48 in FIG. 4 is shown without a cover glass (see FIG. 8) for better illustration. As a result, the touch display 48 does not appear to be flush here with the surface 40 of the upper tube 42. However, this is de facto the case according to the previous embodiments in FIGS. 1 to 3. In addition, the display unit 36 still has some buttons 74 embedded flush with the surface 38 for alternative and/or supplemental haptic control. For example, the display unit 36 can be switched on and off using one of the buttons, while a button 74 is used to switch the views of the touch display 48 and another button 74 is used to change input values. In this context, it is also possible that the display 50 is not configured as a touch display, but rather serves to display information only. Furthermore, a connection socket 76 for data and/or energy transmission with an external device, such as a smartphone or the like, is embedded into the surfaces 38, 40 of the display unit 36 and/or the upper tube 42, which will be discussed in more detail below.

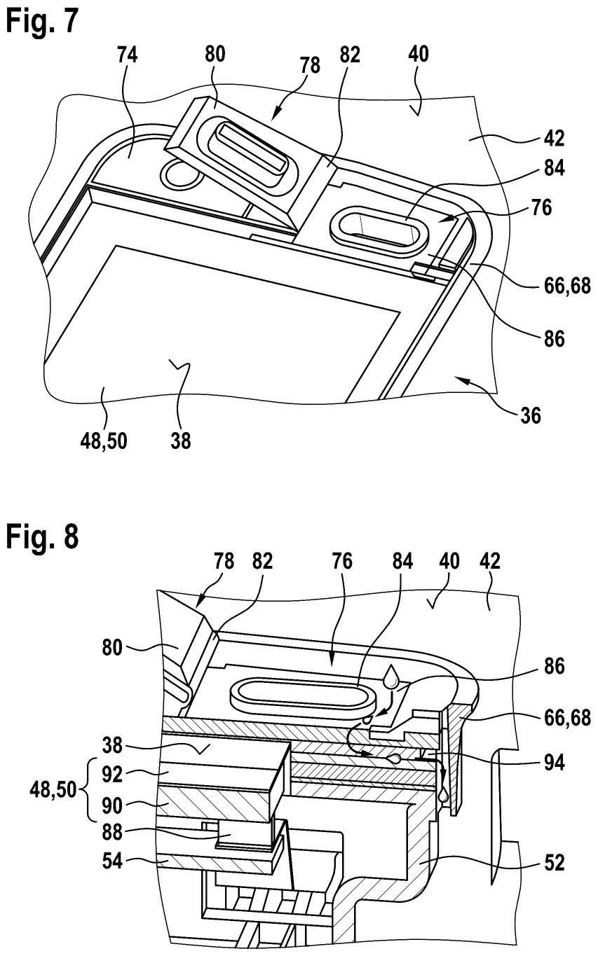

FIG. 7 shows the connection socket 76 of the display unit 36 in a detail view. The connection socket 76 can be closed with a cover cap 78 such that the cover cap 78 is flush with the surfaces 38, 40 of the display unit 36 and/or the upper tube 42 in the closed state, such that the connection socket 76 is protected from any weather and other environmental influences. The cover cap 78 is configured as a two-component cover cap 78 having a lid 80 and a hinge 82. The lid 80 is made of a rigid material, in particular a thermoplastic, such as PC-ABS, while the hinge 82 is made of an elastic material, in particular a thermoplastic elastomer, silicone or rubber. This results in a good sealing function of the cover cap 78 on the one hand and a long service life on the other.

The connector socket 78, typically configured as a USB-C socket, has an electromechanical interface 84 that is raised relative to a surrounding, flat recess 86. The electromechanical interface 84 serves to receive a corresponding USB-C plug. No fluids can run directly into the electromechanical interface 84 due to the raised design compared to recess 86, which prevents corrosion or any short circuits of the electrical contacts of the electromechanical interface 84 and/or significantly reduces the risk.

FIG. 8 shows the display unit 36 in a perspective cut perpendicular to the surfaces 38, 40 of the touch display 48 and/or the upper tube 42. Among other things, the touch display 48, which is electrically connected to the printed circuit board 54 via a connector 88, is shown, which in a very simplified form consists of the layers 90 for the display and for capacitive touch detection as well as the cover glass 92, not shown in FIG. 5 and which forms the surface 38.

The housing 52 of the display unit 36 has a drain channel 94 connected to the recess 86 of the connection socket 76, such that fluids, such as water, can be discharged into the upper tube 42 and/or through the upper tube 42 via the housing 52. Instead of a USB-C socket, other sockets for data and/or energy transfer with the external device, such as USB-A, micro-USB, round sockets or the like, are also possible.

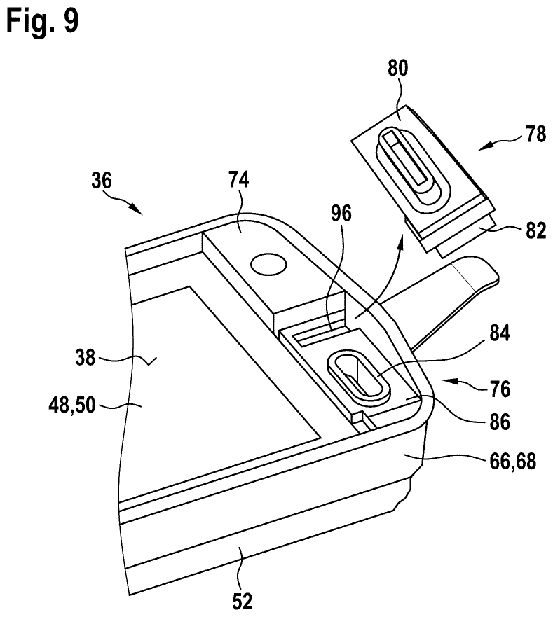

FIG. 9 shows the display unit 36 in a further perspective view with the cover cap 78 removed. To facilitate a replacement of the cover cap 78, its hinge 82 is received in a corresponding retaining groove 96. The hinge 82 can then be inserted and removed from the side without any tools. In an alternative configuration, it can be provided that the connection socket 76 is rotatable about an axis of rotation such that it is flush with the surfaces 38, 42 in the closed state. As a result, the cover cap 78 may be dispensed with. However, such a configured connection socket 76 requires a larger design space and, if necessary, more complexly manufactured contacts.

Finally, it should be pointed out that the exemplary embodiments shown are neither limited to FIGS. 1 through 9 nor to the shapes, quantities and size proportions of the individual elements. These are only to be understood as an example.

What is claimed is:

1. A vehicle driven by an electric motor, comprising:
a frame having a frame surface;
a display unit configured to allow interaction by a rider of the vehicle; and
an intermediate layer,
wherein the display unit is provided in the frame surface, and
wherein the display unit includes a display surface that is integrated flush with the frame surface such that a plane is formed by the intermediate layer arranged between the display unit and the frame.

2. The vehicle according to claim 1, wherein:
the display unit includes a housing, and
the intermediate layer is connected to the housing in a material-locking manner.

3. The vehicle according to claim 1, wherein the intermediate layer is made from an elastic material.

4. The vehicle according to claim 2, wherein the intermediate layer is configured more elastically than the housing.

5. The vehicle according to claim 1, wherein the intermediate layer is deformed in the mounted state of the display unit.

6. The vehicle according to claim 1, wherein the intermediate layer is configured as a seal against intrusion of fluids between the frame and the display unit.

7. The vehicle according to claim 1, wherein the display unit has at least one fastening mechanism and a tolerance compensation element for fastening in the frame.

8. The vehicle according to claim 1, further comprising:
a handlebar; and
a saddle,
wherein the frame includes an upper tube that is arranged between the handlebar and the saddle, and
wherein the upper tube includes the frame surface.

9. A display unit, comprising:
a display;
an intermediate layer; and
a housing for a vehicle driven by an electric motor,
wherein the housing and the display are connected to the intermediate layer in a material-locked manner for flush integration into a frame of the vehicle.

10. The vehicle according to claim 1, wherein the vehicle is a one-wheeler or two-wheeler driven by the electric motor.

11. The vehicle according to claim 3, wherein the elastic material is a thermoplastic elastomer or silicone.

12. The vehicle according to claim 1, wherein the intermediate layer is compressed in the mounted state of the display unit.

13. The vehicle according to claim 1, wherein the display unit has a screw or screw dome and a leaf spring for fastening in the frame.

14. The display unit of claim 9, wherein the display is a touch display.
